(19) United States
(12) Patent Application Publication
(10) Pub. No.: US 2009/0094484 A1
(43) Pub. Date: Apr. 9, 2009

(54) SYSTEM AND METHOD FOR AUTONOMOUSLY PROCESSING FAULTS IN HOME NETWORK ENVIRONMENTS

(75) Inventors: Young Sung SON, Daejeon (KR); Tai Yeon KU, Busan (KR); Jun Hee PARK, Daejeon (KR); Kyeong Deok MOON, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/102,149

(22) Filed: Apr. 14, 2008

(30) Foreign Application Priority Data
Oct. 5, 2007 (KR) 10-2007-0100264

(51) Int. Cl. G06F 11/07; G06N 5/02

(52) U.S. Cl. 714/26; 714/E11.021

(57) ABSTRACT

There are provided a fault processing system and method for quickly and accurately diagnosing a fault and autonomously processing the fault, based on interdependencies between various devices, networks, systems, and services in home network environments, the method including: establishing fault detection rules for detecting faults belonging to respective fault types defined for each situation by classifying faults occurring in the home network environments, fault diagnosis rules for diagnosing a fault type of a fault, and fault processing rules defining a method of solving a fault for each fault type; collecting state information of devices, networks, services, and the system in the home network environments and detecting a fault based on the fault detection rules; diagnosing the fault type of the detected fault by applying the fault diagnosis rules; and processing the detected fault based on the fault processing rules according to the diagnosed fault type.

### CROSS-REFERENCE TO RELATED APPLICATIONS

This application claims the priority of Korean Patent Application No. 2007-0100264 filed on Oct. 5, 2007, in the Korean Intellectual Property Office, the disclosure of which is incorporated herein by reference.

### BACKGROUND OF THE INVENTION

1. Field of the Invention

The present invention relates to an autonomous fault processing system for home network environments and a method of operating the system, the system detecting a fault occurring in the home network environments for each fault type and autonomously processing the fault according to a fault processing rule established for each fault type.

The present invention was partly supported by the IT R&D program of MIC/IITA [2006-S-066-2, Development of High Reliable Adaptive Middleware for u-Home].

2. Description of the Related Art

Home network indicates a network integrating all kinds of electronic devices at home by applying various wired and wireless technologies, which is connected to external networks via a residential gateway (RG) in such a way a user not only receives and controls various services but also is notified an emergency situation and accurately manage the emergency situation, regardless of a location of the user.

A home network system is formed of various kinds of devices, networks, and services.

For example, devices including various kinds of home appliances and communication devices are connected via a local area network (LAN) such as universal plug and play (UPnP), Z256, LonWorks, Zigbee, LnCP, and S3.

In addition, to solve interoperability problems among different types of home network middlewares, a universal middleware bridge (UMB) connecting and relaying different middleware networks in the home network system has been developed.

By the UMB system, devices connected to different middleware networks in the home network system may interoperate.

In such home network environments, since fault interdependently occurs among various devices, networks, and services, it is very difficult to detect and accurately recover a root cause of a fault.

Nowadays, there is no standard fault processing model in home network environments. Though many technologies have been researched, many of them have been tried without considering particularities of home network environments in which various kinds of devices, networks, and services interoperate.

However, fault management in home network environments requires an autonomous model based on participating objects and interdependency thereof.

Also, since most of users of homes where home network systems are installed are not experts, there is required fault processing mechanism capable of detecting a fault of home network and autonomously executing fault recovery.

### SUMMARY OF THE INVENTION

An aspect of the present invention provides fault processing mechanism capable of quickly accurately diagnosing a fault based on interdependency among various devices, networks, systems, and services in home network environments and autonomously processing the fault based on the diagnosis to recover the fault.

According to an aspect of the present invention, there is provided an autonomous fault processing method for home network environments, the method including: establishing fault detection rules for detecting faults belonging to respective fault types defined for each situation by classifying faults occurring in the home network environments, fault diagnosis rules for diagnosing a fault type of a fault, and fault processing rules defining a method of solving a fault for each fault type; collecting state information of devices, networks, services, and the system in the home network environments and detecting a fault based on the fault detection rules; diagnosing the fault type of the detected fault by applying the fault diagnosis rules; and processing the detected fault based on the fault processing rules according to the diagnosed fault type.

According to another aspect of the present invention, there is provided an autonomous fault processing system for home network environments, the system including: a storage storing fault detection rules for detecting faults occurring in the home network environments, fault diagnosis rules for diagnosing a fault type defined by classifying the faults for each situation, and fault processing rules defining a method of processing a fault for each fault type, and state information collected from the home network environments; a fault detection module collecting the state information on devices, networks, services, and the system in the home network environments and detecting and reporting a fault based on the fault detection rules; a fault diagnosis module diagnosing the type of a fault detected by the fault detection module by applying the fault diagnosis rules; and a fault processing module processing the detected fault by applying the fault processing rules according to the fault type diagnosed by the fault diagnosis module.

As described above, according to the present invention, in home network environments in which various kinds of devices, networks, systems, and services are included and the services are executed controlling the respective devices via a network, when a device fault, a network fault, and a service fault occurs therein, the faults are detected and a type for each of the faults is interpreted, fault detection rules, fault diagnosis rules are searched to process the fault based on the type of the fault, and a most accurate fault processing method is applied, thereby autonomously processing the fault.

In addition, whenever a new fault type is detected in the home network environments, a fault detection rule, a fault diagnosis rule, and a fault processing rule for the fault type are added in such a way that the new fault is easily processed, thereby easily maintaining and recovering a home network.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating a configuration of entire home network environments employing a fault processing system according to an exemplary embodiment of the present invention;

FIG. 2 is a diagram illustrating fault processing mechanism according to an exemplary embodiment of the present invention;

FIG. 3 is a block diagram illustrating a detailed configuration of an autonomous fault processing system according to an exemplary embodiment of the present invention; and

FIG. 4 is a flowchart illustrating operations of the autonomous fault processing system of FIG. 3.

### DETAILED DESCRIPTION OF THE PREFERRED EMBODIMENT

Hereinafter, exemplary embodiments of the present invention will now be described in detail with reference to the accompanying drawings.

Only, in describing operations of the exemplary embodiments in detail, when it is considered that a detailed description on related well-known functions or constitutions unnecessarily may make essential points of the present invention be unclear, the detailed description will be omitted.

Also, in the drawings, the same reference numerals are used throughout to designate the same or similar components.

In addition, throughout the specification, when it is describe that a part is “connected to” another part, this includes not only a case of “being directly connected to” but also a case of “being indirectly connected to”, interposing another device therebetween.

Also, when it is described that an apparatus “includes” an element and there is no opposite description thereof, this is not designate that the apparatus excludes other elements but designates that the apparatus may further include other elements.

Also the term of “module” indicates a unit for processing a certain function or operation, which can be embodied by software, hardware, or a combination of software and hardware.

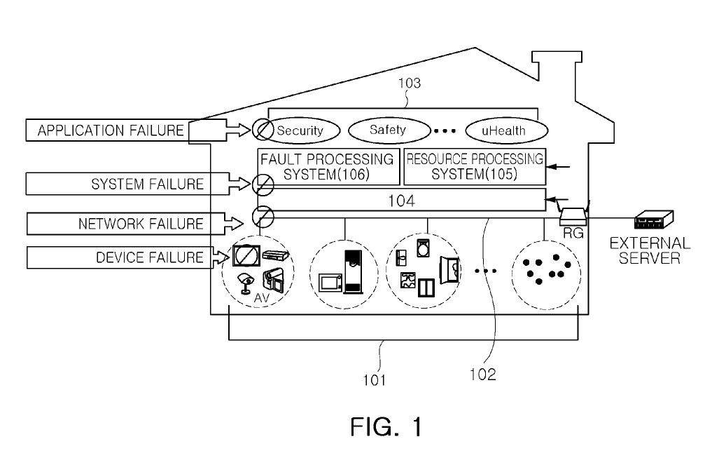

FIG. 1 is a block diagram illustrating a configuration of an entire home network system employing a fault processing system 106 according to an exemplary embodiment of the present invention.

Referring to FIG. 1, the home network system includes one or more of devices 101 installed or located at home and performing a predetermined function, such as audiovisual (A/V) devices, a control device, and detectors, one or more of networks 102 for transmitting data and a control signal with the devices 101, and an application 103 executing a security service, a safety service, and a health service by controlling the devices 101 via the networks 102.

The home network 102 is connected to external servers via a residential gateway.

The home network system further includes a home network management 104 managing various kinds of the devices 101 and networks 102, a resource processing system 105 managing resources in home network environments, and the fault processing system 106 processing faults occurring in the home network environments.

The present invention relates to the fault processing system 106. The fault processing system 106 detects a fault from device state information, home network state information, and service state information in the home network environments, determines a fault type of the fault, and applies a fault processing rule according to the determined fault type, thereby autonomously processing the fault.

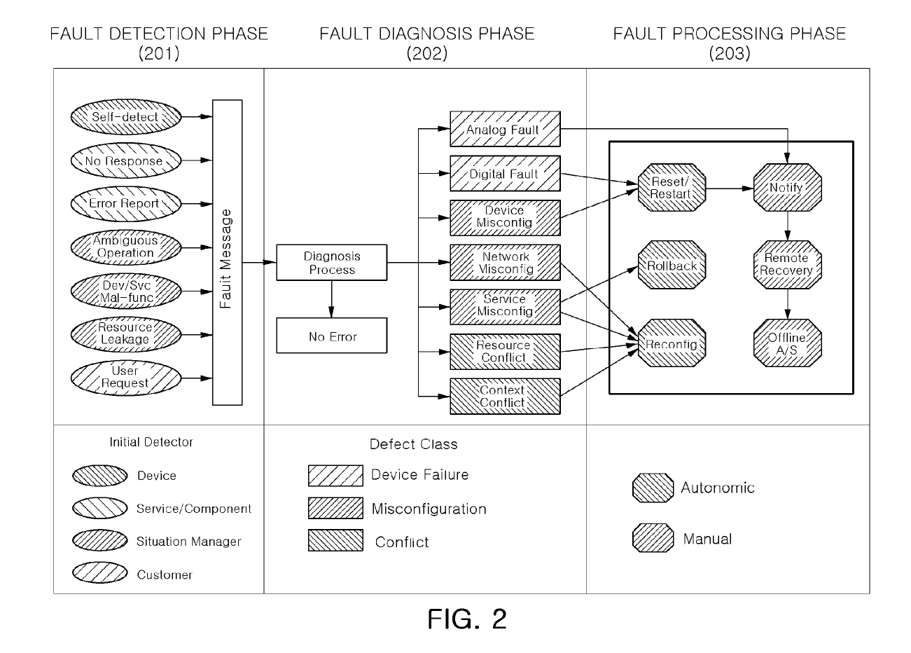

FIG. 2 is a diagram illustrating fault processing mechanism of the fault processing system 106, according to an exemplary embodiment of the present invention.

Referring to FIG. 2, fundamental concepts of the fault processing mechanism of the fault processing system 106 will be described.

As operations of the fault processing system 106, there are a fault detection phase 201, a fault diagnosis phase 202, and a fault recovery phase 203.

In the fault detection phase 201, the fault processing system 106 detects fault occurrence in a home network by various methods. In detail, device state information, system state information, and service state information are collected from devices, service/configuration elements, a state administrator, and a user and a fault message is generated when a fault is detected. In this case, to detect to the fault, preset fault detection rules may be applied. The fault detection rules define rules for detecting fault occurrence from the device state information, system state information, and service state information, which is previously established.

Examples of general faults capable of being detected in the fault detection phase 201 are shown in Table 1.

TABLE 1

| | | Requirement | |
|---|---|---|---|
| | | diagnosis | |
| Appearance | Information | method | Functionality |
| Self-detect | Self-detection | Self-diagnosis | Embedded |
| | information | process | self-diagnosis |
| | | | mechanism |
| No response | AcK, time-out | Transaction or | Request/response |
| | | heartbeat | transaction |
| | | | periodic |
| | | | heartbeat |
| Error report | Fault code | Standard fault | Standard fault |
| | | code | code |
| Ambiguous | Context value | Home context | Home context |
| operation | abnormal | management | management |
| | situation | context-based | context model |
| | control | service model | context pattern |
| | conflict | | management |
| | | | context |
| | | | conflict check |
| | | | brokering |
| | | | virtual world and |
| | | | real world |
| Device/service | Context value | Home context | Home context |
| malfunction | abnormal | management | management |
| | control result | | brokering |
| | | | virtual world and |
| | | | real world |
| | | | device/service |
| | | | function |
| | | | description |
| Resource | Permenant of | Management of | Resource |
| leakage | temporal | resource | management |
| | service quality | capacity/ | resource |
| | degrade | usage/ | clarification |
| | | reservation | model |
| | | | definition |
| | | | home topology |
| | | | map |
| | | | resource |
| | | | monitoring |
| User request | User input | User decision | User managing |

In Table 1, self-detection indicates that a device reports a fault code of its own. No response, which is recognized by a service or a system, indicates a case when a response is not received and time-out occurs. Error report may be recognized from a wrong response message or a return value. Ambiguous operation may be detected after a service or a device performs an operation. Device/service malfunction indicates a case when a service or device operates but do abnormal behavior. Resource leakage may be shown when a service or a device supports quality of service (QoS). Also, when a user may explicitly requests fault processing. In this case, it is recognized by the request of the user. There are described representative faults. Various types of faults may be additionally shown.

That is, in the fault detection phase 201, the fault processing system 106 detects a fault occurrence such as the self-detection, the no response, the ambiguous operation, the device/service malfunction, the resource leakage, and the user request from the various state information collected from the device, system, network, and services by applying the fault detection rules previously established and generates the fault message for reporting the fault occurrence.

In the fault diagnosis phase 202, the fault processing system 106 determines whether a fault actually occurs and a type of the fault by analyzing the fault message. The fault type is defined by classifying faults occurring in home network environments for each situation. For example, as the fault type, there are an analog fault, a digital fault, device misconfiguration, network misconfiguration, service misconfiguration, a resource conflict, and a context conflict. The fault type is defined based on general faults capable of occurring in present home network environments. When there is detected a new fault that does not correspond to the defined fault types, a new fault type may be defined. In the present invention, fault diagnosis rules previously established are applied in the fault diagnosis phase 202. The fault diagnosis rules define rules for diagnosing a type of a fault currently occurring. Whenever defining a new fault, a fault diagnosis rule suitable for the new fault is added, thereby diagnosing an occurrence of a new fault type in the fault diagnosis phase 202.

In the fault recovery phase 203, the fault processing system 106 performs recovery operations suitable for the fault type diagnosed in the fault diagnosis phase 202. For example, as the recovery operations, there are reconfiguration of a context, a resource, a service, and a network, rollback, reset/restart, notification, remote recovery, and a connection to an offline after service (A/S) center. In the fault recovery phase 203, monitoring is further performed in addition to the recovery operations. That is, a fault code of the detected fault is reported to the user. As shown in FIG. 2, the fault recovery includes both of autonomous recovery executed without intervention of an administrator and manual recovery executing a requested recovery according to the intervention of the administrator. For example, as shown in FIG. 2, when a fault corresponding to the network misconfiguration, the service misconfiguration, the resource conflict, and the context conflict, a network, a service, a resource, or a context where a fault occurs is reconfigured. In the case of the service misconfiguration, the rollback may be executed in addition to the service reconfiguration. In the case of one of the device misconfiguration and the digital fault, a corresponding device is processed to be reset/restart. In the case of the analog fault, the user is notified to request the remote recovery or the offline A/S. Similarly, when a fault is not yet solved after processing the fault, the notification, the remote recovery, or the offline A/S may be requested.

To autonomously process a fault, the fault processing system 106 previously establishes fault processing rules defining a processing method for each fault type. In the fault recovery phase 203, a fault processing rule suitable for the diagnosed fault type is interpreted and a fault recovery is executed according to the interpretation. A new suitable fault processing rule may be added when there is detected a new fault type.

As described above, to process a fault, it is required to previously define a fault type, which may be defined by a fault cause, a fault state, and a fault recovery method.

The fault cause and the fault state are shown when a fault occurs.

Accordingly, for the fault detection phase 201, there may be provided a fault detection module capable of establishing the fault detection rule for detecting all types of faults based on the fault cause and fault state with respect to all of the presently established fault types and detecting the all types of faults.

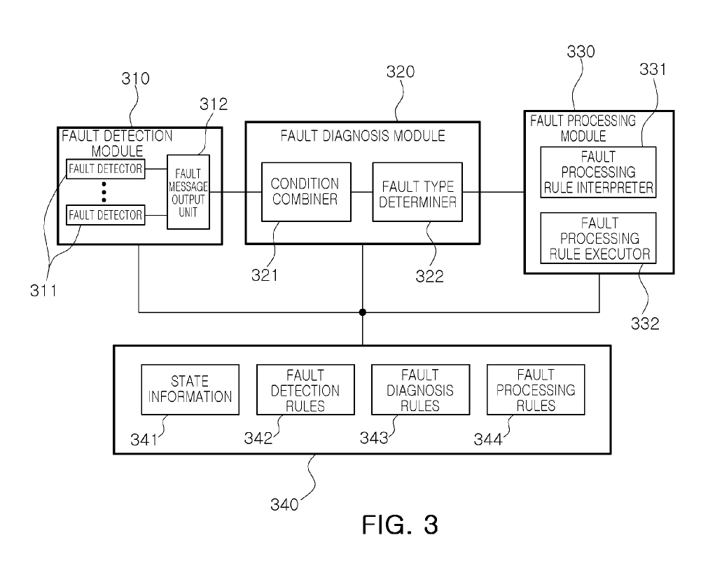

FIG. 3 is a block diagram illustrating an autonomous fault processing system according to an exemplary embodiment of the present invention.

Referring to FIG. 3, the autonomous fault processing system includes a fault detection module 310 collecting information on various states occurring in home network environments and reporting the information by using a fault message, a fault diagnosis module 320 diagnosing what type of a fault occurs via the fault message outputted from the fault detection module 310, a fault processing module 330 processing the fault by applying a fault processing rule established according to the fault type diagnosed by the fault diagnosis module 320, and a storage 340 storing rules 342 to 344 for operations of the fault detection module 310, the fault diagnosis module 320, and the fault processing module 330 and state information 341.

The fault detection module 310 includes one or more of fault detectors 311 collecting device state information, system state information, and network state information and a fault message output unit 312 forming and outputting a fault message by using the state information collected by the fault detectors 311.

The fault detectors 311 detects various faults as shown in FIG. 2, such as a self-detected fault, no response from a service or system, an error report, ambiguous operation, device/service malfunction, resource leakage, and fault occurrence inputted by a user.

The fault diagnosis module 320 includes a condition combiner 321 analyzing the fault message outputted from the fault detection module 310 according to the fault diagnosis rules 343 of the storage 340 and a fault type determiner 322 determining a fault type according to a result of the analysis of the condition combiner 321. The condition combiner 321 continuously receives the state information including a functional state of a device, resource usage of a network, and operation information of a service and combines the state information and transmits the combined state information for fault diagnosis to the fault type determiner 322. The fault type determiner 322 diagnoses whether a fault occurs and a type of the fault, by using various types of the state information transmitted from the condition combiner 321 and the fault diagnosis rules 343 describing features of the fault. The fault diagnosis rules are formed of a fault type, evidences such as a functional state of a device, and a description.

The fault processing module 330 includes a fault processing rule interpreter 331 reading and interpreting a fault processing rule according to the fault type determined by the fault diagnosis module 320 and a fault processing rule executor executing the fault processing rule interpreted by the fault processing rule interpreter 331.

In addition, the fault processing module 330 displays a cause and a recovery method of the fault to a user, according to the diagnosis result of the fault diagnosis module 320. In this case, the display is provided by graphic user interface (GUI). The GUI is formed of a display board and a fault processing board. The display board displays the state information of a home network, collected by the fault detection module 310, and the fault processing board displays fault information such as a fault type code, a fault cause, and a recovery method of the fault, after processing the fault.

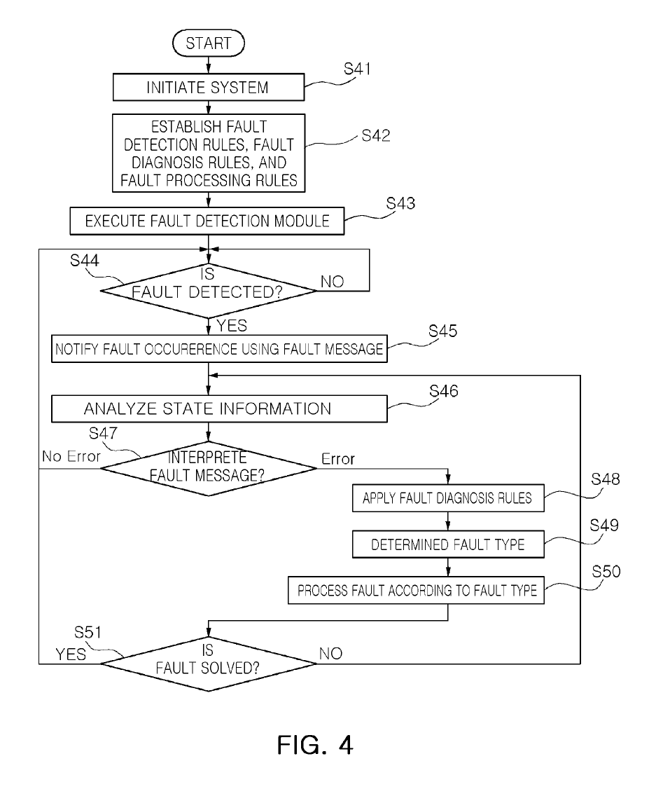

FIG. 4 is a flowchart illustrating operations of the fault processing system of FIG. 3. Hereinafter, the operations of the fault processing system will be sequentially described with reference to FIG. 4.

Referring to FIG. 4, the fault processing system is initiated (S41) and establishes fault detection rules, fault diagnosis rules, and fault processing rules (S42).

When the establishing all of the rules for processing faults is finished, the fault detection module 310 is operated by the fault processing system (S43). A plurality of the fault detectors 311 included in the fault detection module 310 collect various types of state information on home network environments.

When there is detected state information suspicious as a fault (S44), the fault detection module 310 notifies the fault diagnosis module 320 that the fault occurs, by using a fault message (S45).

When the fault message is received, the fault diagnosis module 320 analyzes present state information of a home network (S46) and interprets the fault message (S47).

As a result of the interpreting the fault message, when there is no fault, the fault message is disregarded and fault detection is continuously performed. On the other hand, when a fault actually occurs, the fault detection module 320 determines a type of the fault by applying the fault diagnosis rules (S48 and S49).

The fault processing rule established for the determined fault type is executed (S50).

After executing the fault processing rule, when the fault is solved (S51), fault detection is continuously performed. When the fault is not solved, S46 is repeated to apply and execute another fault processing rule by reanalyzing state information.

The operations from S46 to S50 are repeatedly performed until the fault detected in the home network environments is solved.

While the present invention has been shown and described in connection with the exemplary embodiments, it will be apparent to those skilled in the art that modifications and variations can be made without departing from the spirit and scope of the invention as defined by the appended claims.

What is claimed is:

1. An autonomous fault processing method for home network environments, the method comprising:
establishing fault detection rules for detecting faults belonging to respective fault types defined for each situation by classifying faults occurring in the home network environments, fault diagnosis rules for diagnosing a fault type of a fault, and fault processing rules defining a method of solving a fault for each fault type;
collecting state information of devices, networks, services, and the system in the home network environments and detecting a fault based on the fault detection rules;
diagnosing the fault type of the detected fault by applying the fault diagnosis rules; and
processing the detected fault based on the fault processing rules according to the diagnosed fault type.

2. The method of claim 1, wherein the fault type is defined by a fault cause, a fault state, and a recovery method.

3. The method of claim 2, wherein the fault type comprises one or more of analog faults, digital faults, device misconfiguration, network misconfiguration, service misconfiguration, resource conflicts, and context conflicts.

4. The method of claim 2, wherein the fault processing rules comprises one or more of a context, a resource, network reconfiguration, rollback, reset/restart, notify, remote recovery, and connection to an offline after service center.

5. An autonomous fault processing system for home network environments, the system comprising:
a storage storing fault detection rules for detecting faults occurring in the home network environments, fault diagnosis rules for diagnosing a fault type defined by classifying the faults for each situation, and fault processing rules defining a method of processing a fault for each fault type, and state information collected from the home network environments;
a fault detection module collecting the state information on devices, networks, services, and the system in the home network environments and detecting and reporting a fault based on the fault detection rules;
a fault diagnosis module diagnosing the type of a fault detected by the fault detection module by applying the fault diagnosis rules; and
a fault processing module processing the detected fault by applying the fault processing rules according to the fault type diagnosed by the fault diagnosis module.

6. The system of claim 5, wherein the fault type is defined by a fault cause, a fault state, and a recovery method.

7. The system of claim 6, wherein the fault type comprises one or more of analog faults, digital faults, device misconfiguration, network misconfiguration, service misconfiguration, resource conflicts, and context conflicts.

8. The system of claim 6, wherein the fault processing rules comprises one or more of a context, a resource, network reconfiguration, rollback, reset/restart, notify, remote recovery, and connection to an offline after service center.

9. The system of claim 5, wherein the fault detection module comprises:
one or more of fault detectors collecting device state information, system state information, and home network state information, respectively; and
a fault message output unit analyzing the state information collected by the one or more of fault detectors according to the fault detection module and generating a fault message when there is detected a fault.

10. The system of claim 5, wherein the fault diagnosis module comprises:
a condition combiner combining the state information collected by the fault detection module when the fault is reported by the fault detection module; and
a fault type determiner determining the fault type by analyzing the state information combined by the condition combiner according to the fault diagnosis rules.

11. The system of claim 5, wherein the fault processing module comprises:
a fault processing rule interpreter reading and interpreting the fault processing rule according to the fault type diagnosed by the fault diagnosis module from the storage; and
a fault processing rule executor executing the fault processing rule interpreted by the fault processing rule interpreter.

12. The system of claim 11, wherein the fault processing module displays a cause and a recovery method of the fault according to a diagnosis result of the fault diagnosis module.

13. The system of claim 12, wherein the fault processing module displays fault information comprising one or more of home network state information collected by the fault detection module, after processing the fault, a fault type code, a fault cause, and a fault recovery method.
